(19) United States
(12) Patent Application Publication
(10) Pub. No.: US 2024/0159530 A1
(43) Pub. Date: May 16, 2024

(54) ADAPTER FOR MOUNTING A MESAURING MARK AT A REFERENCE POINT

(71) Applicant: Georg Rothbucher, Bad Reichenhall (DE)

(72) Inventor: Georg Rothbucher, Bad Reichenhall (DE)

(21) Appl. No.: 18/494,320

(22) Filed: Oct. 25, 2023

(30) Foreign Application Priority Data
Nov. 14, 2022 (EP) 222072076

(51) Int. Cl. G01C 15/06

(52) U.S. Cl. CPC G01C 15/06

(57) ABSTRACT

Described is an adapter for attaching a measuring mark at a reference point. The adapter includes an adapter body to which a measuring mark is fixedly attachable or detachably attachable. At least a portion of the adapter body is formed into a plug that is adapted to a socket serving as a reference point such that it is insertable into the socket to establish a positive plug-in connection and is electrically insulated from the socket when inserted.

### CROSS-REFERENCE TO RELATED APPLICATIONS

This application claims the benefit of European Application 22207207.6, filed Nov. 14, 2022, which is incorporated herein in their entireties.

### TECHNICAL FIELD

The invention relates to an adapter for mounting a measuring mark at a reference point. Furthermore, the invention relates to a device for surveying a reference point comprising an adapter and a measuring mark, as well as a method for surveying a reference point using an adapter.

### BRIEF DESCRIPTION

Measuring or surveying marks are usually mounted to stationary objects such as in or on buildings. They serve there as survey points, which are surveyed using inherently known measuring devices such as lasers, scanners and total stations.

It is of particular importance to mount such a measuring mark in a defined position. In a number of applications, it must be ensured that this defined position forms a reference point that remains unchanged over time. For example, it may be necessary to use one and the same reference point at different times in a large number of measurements. In such a situation, it is time-consuming and error-prone to define the reference point again for each measurement.

To mount a measuring mark in a defined position, some applications use a standardized measuring bolt that is firmly attached to the object to be surveyed. The measuring mark is then attached to the measuring bolt. This ensures that the reference point only needs to be established once and can also be used in subsequent measurements. However, such a determination of the reference point is relatively complex and expensive as a result of the use of a measuring bolt specially designed for this purpose.

The invention is based on the object of enabling a measuring mark to be mounted at a reference point in a particularly simple and cost-effective manner.

This object is solved by an adapter according to claim 1. Advantageous embodiments are the subject-matter of the dependent claims and the following description.

The adapter according to the invention comprises an adapter body to which a measuring mark is fixedly attached or attachable. At least a part of the adapter body is shaped into a plug which is adapted to a socket serving as a reference point in such a way that it can be plugged into the socket to produce a positive plug connection and is electrically insulated from the socket in the plugged-in state.

The solution according to the invention takes advantage of the fact that a socket defines a point with a fixed position which can be used as a reference point in a surveying operation. In addition, this solution takes advantage of the fact that a socket is designed to cooperate in a well-defined manner with a plug adapted to the socket in order to realize a positive plug connection therewith. The invention now provides an adapter carrying the measuring mark with a plug which is adapted in its design to a conventional socket in order to establish a positive plug connection with the socket. This makes it possible to attach the measuring mark to a fixed reference point simply by plugging the adapter into the socket.

In addition, to allow the user to safely attach the measuring mark at the reference point, the adapter is designed to be electrically insulated from the socket when plugged in, unlike a plug that interacts with the socket in a conventional manner.

The plug is preferably shaped according to a type of network plug usable for connection to a low-voltage network. For example, the plug is adapted to one of the common types of network plugs used in various countries or regions for connecting electrical appliances and lighting fixtures in the lowest level of low-voltage networks. The following plug types are to be mentioned here merely by way of example and without limitation to these examples:
Plug type F/“Schuko plug” (CEE 7/4)
Plug type C/“contour plug” (CEE 7/17)
Plug type C/“Euro plug” (CEE 7/16)
Plug type N (IEC 60906-1)
Plug type SN 441011 type 12
Plug type D (BS 546, 5 A)
Plug type E (CEE 7/5)
Plug type B (NEMA 5-15, 3-pin)
Plug type M (BS 546, 15 A)
Plug type K (DS 60884-2-D1)
Plug type G/“Commonwealth plug” (BS 1363)
Plug type I/(AS 3112)
Plug type J (SEV 1011)
Plug type L (CEI 23-50)
Plug type M (BS 546, 15 A)

In a preferred embodiment, the adapter body has the measuring mark or a mounting element for detachably attaching the measuring mark at its end facing away from the plug. The position of the reference point is thus determined by the dimension of the adapter end facing away from the plug, to which the measuring mark is attached.

Preferably, the mounting element is an adapter plate to which the measuring mark can be detachably attached. The measuring mark can be attached to the adapter plate, for example, by means of a screw connection, a plug-in connection, an adhesive connection or also magnetically.

If a magnetic coupling of the measuring mark to the adapter is provided, then in a particularly preferred embodiment the adapter plate is made of metal, for example a corrosion-resistant steel.

In this embodiment, the measuring mark preferably has a magnet arrangement that can be attached to the adapter plate made of metal. This makes it particularly easy to attach the measuring mark to the adapter merely magnetically, i.e. without additional fasteners. For example, the measuring mark can be provided with a base on the underside of which the magnet arrangement is located.

For example, the plug has at least one contact pin that is adapted to an associated contact opening of the socket. This means that the contact pin is brought into positive engagement with the contact opening when the plug formed on the adapter is inserted into the socket.

The plug can also have, for example, at least one recess that is adapted to a grounding lug of the socket. When plugged in, the grounding lug of the socket is thus received in the recess formed in the plug, whereby a positive plug connection is established. In addition or alternatively, the plug can also have a projection that is adapted to a recess in the socket.

In a preferred embodiment, the adapter as a whole is made of an electrically insulating material, e.g. a plastic. This ensures that the plug is particularly reliably electrically insulated from the socket when plugged in. However, it is not absolutely necessary to make the entire adapter electrically insulated, provided that the electrical insulation of the adapter from the socket is ensured. For example, individual contact pins of the adapter may well be electrically conductive, as in the case of a conventional electrical plug. It must then be ensured that the electrical insulation of the adapter from the socket is achieved in another way, for example by embedding the contact pins in the electrically insulating material of the adapter body.

The adapter is preferably made of an injection molded part. The use of an injection molding process in production allows a free choice of the shape and surface structure of the adapter. This allows a desired plug shape to be realized in almost any way in adaptation to the respective socket type, which is used as a reference point.

According to another aspect of the invention, there is provided a device for surveying a reference point comprising an adapter of the type described above and a measuring mark removably attached to the adapter body.

In a preferred embodiment of this device, the measuring mark has a recess which is adapted in shape to an adapter plate of the type described above. For example, the recess and, adapted thereto, the adapter plate each have the shape of a regular polygon with rounded corners. Such a shape makes it easier for the user to insert the adapter plate in the correct position in the recess of the measuring mark. It is of particular advantage if the measuring mark is part of a whole range of marks, all of which have a recess of the above type and are thus designed to be placed on the adapter plate in the same way for mounting at a reference point.

Any type of mark can be used as a measuring mark, such as a reflective target mark, an adhesive mark, a survey badge, a prism, a laser scanner sphere, or the like.

According to a further aspect of the invention, there is provided a device comprising a socket and an adapter of the type described above, the plug of which is insertable into the socket to form a positive plug-in connection and is electrically insulated from the socket when inserted.

Finally, the invention provides a method for surveying a reference point using an adapter of the type described above. In this method, the adapter is attached to a socket serving as a reference point by inserting the part of the adapter body shaped into the plug into the socket, thereby establishing a positive and electrically insulated connection with the socket.

### BRIEF DESCRIPTION OF THE DRAWINGS

The invention is explained in more detail below with reference to the figures.

FIG. 1 shows a perspective view of an adapter according to a first embodiment,

FIG. 2 shows a front view of the adapter according to the first embodiment,

FIG. 3 shows a rear view of the adapter according to the first embodiment,

FIG. 4 shows a side view of the adapter according to the first embodiment,

FIG. 5 shows a perspective view of an adapter according to a second embodiment,

FIG. 6 shows a perspective view of an adapter according to a third embodiment,

FIG. 7 shows a perspective view of an adapter according to a fourth embodiment,

FIG. 8 shows a side view of an adapter according to a fifth embodiment,

FIG. 9 shows another side view of the adapter according to the fifth embodiment,

FIG. 10 shows a perspective view of an adapter according to a sixth embodiment,

FIG. 11 shows a front view of the adapter according to the sixth embodiment,

FIG. 12 shows a rear view of the adapter according to the sixth embodiment,

FIG. 13 shows a side view of the adapter according to the sixth embodiment,

FIG. 14 shows another side view of the adapter according to the sixth embodiment,

FIG. 15 shows a perspective view of an adapter according to a seventh embodiment,

FIG. 16 shows a front view of the adapter according to the seventh embodiment,

FIG. 17 shows a rear view of the adapter according to the seventh embodiment,

FIG. 18 shows a side view of the adapter according to the seventh embodiment,

FIG. 19 shows another side view of the adapter according to the seventh embodiment,

FIG. 20 shows a perspective view of an adapter according to an eighth embodiment,

FIG. 21 shows a front view of the adapter according to the eighth embodiment,

FIG. 22 shows a rear view of the adapter according to the eighth embodiment,

FIG. 23 shows a side view of the adapter according to the eighth embodiment,

FIG. 24 shows another side view of the adapter according to the eighth embodiment,

FIG. 25 shows a perspective front view of an adapter according to a ninth embodiment, and

FIG. 26 shows a perspective rear view of the adapter according to the ninth embodiment.

### DETAILED DESCRIPTION

In the following, an adapter according to the invention is described with reference to specific embodiments.

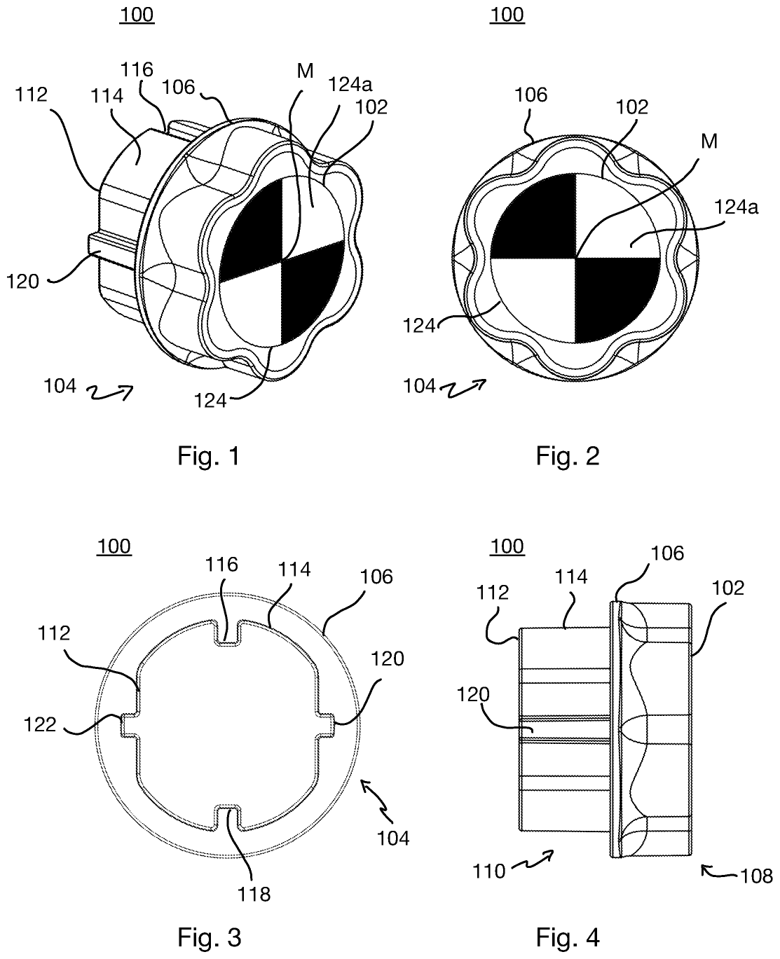

FIGS. 1 to 4 show an adapter 100, which represents a first embodiment, in various views. Here, FIG. 1 shows a perspective view, FIG. 2 shows a front view, FIG. 3 shows a rear view, and FIG. 4 shows a side view of the adapter 100.

The adapter 100 is designed to attach a measuring mark 102 to a reference point. This reference point is defined in this and in all further embodiments respectively by a socket, which is not shown in the figures. This socket is designed, for example, to establish an electrical plug connection with a network plug intended for connection of an electrical appliance in a low-voltage network.

In the embodiment according to FIGS. 1 to 4, the plug type matched to the socket is type F (CEE 7/4), which is predominantly used in Europe and is also known there by the acronym “Schuko plug”. It goes without saying that the reference to this particular electrical plug connection is to be understood only as an example. Reference may also be made to other common plug connector systems.

The adapter 100 has an adapter body 104 which, in this particular example, is roughly shaped like a cylinder. The axis of the cylinder passes through a center point M of the measuring mark 102. On closer inspection, the adapter body 104 has a circular circumferential flange 106 that is axially disposed approximately midway perpendicular to the axis of the cylinder. The flange 106 divides the adapter body 104 into two sections 108 and 110 that extend axially from the flange 106 in opposite directions. Referring to FIG. 4, the section 108 extends from the flange 106 to the right in the forward direction, while the section 110 extends to the left in the rearward direction.

The portion of the adapter body 104 forming the rear portion 110 is formed into a plug 112. The shape of the plug 112 is adapted to the socket such that the plug 112 can be inserted into the socket to form a positive plug connection with the latter. This means that, in this particular example, the plug 112 formed on the adapter body 104 is substantially adapted in its external shape to a conventional Schuko plug that can be inserted into the socket to establish an electrical plug connection. In this regard, it is possible, but not mandatory, that the plug 112 formed on the adapter body 104 adopts the shape of a Schuko plug identically in all details. In any case, it must be ensured that the shape of the plug 112 corresponds to the shape of a Schuko plug at least to the extent that the desired positive plug connection with the socket is achieved.

For example, in the adapter 102 shown in FIGS. 1 to 4, it is sufficient that an outer circumferential surface of the plug 112 designated 114 is reproduced in accordance with the outer circumferential surface of a Schuko plug. Accordingly, two elongated recesses 116, 118 and two elongated protrusions 120, 122 are formed on the outer peripheral surface 114 of the plug 112, each extending in the axial direction. As can be seen in the rear view according to FIG. 3, the two recesses 116, 118 have an angular spacing of 180° in the circumferential direction. The same applies to the two projections 120, 122. The arrangement of the projections 120, 122 as a whole is offset by an angle of 90° in the circumferential direction relative to the arrangement formed by the two recesses 116, 118.

The two recesses 116, 118 of the plug 112a are adapted to associated grounding lugs provided in the socket not shown in the figures. Correspondingly, the two projections 120, 122 of the plug 112 are adapted to associated recesses of the socket. When the plug 112 of the adapter 100 is inserted into the socket, the recesses 116, 118 and the projections 120, 122 of the plug 112 formed on the adapter 100a engage with their associated grounding lugs and recesses of the socket, respectively. Thus, the adapter 100 is positively secured in the socket.

In the embodiment shown in FIGS. 1 to 4, the plug 112 does not have any pin elements that would correspond to the contact pins provided in a conventional Schuko plug. In this example, a sufficiently stable positive connection can be achieved without such pin elements. However, this does not preclude providing corresponding pin elements with the adapter 100 to make the positive connection of the adapter 100 to the socket even more stable.

In order to enable the user to safely insert the adapter 100 into the socket, the plug 112 is designed such that it is electrically insulated from the socket when plugged in. For this purpose, in the embodiment shown, the adapter 100 as a whole is made of an electrically insulating material, for example a plastic. For example, the adapter 100 may be manufactured in the form of a one-piece injection molded part.

For example, the measuring mark 102 is a laser scanner mark that includes a pattern 124 having four sectors 124a. The pattern 124 allows, for example, spatial reference information to be assigned to a geospatial dataset. The measuring mark 102 may be attached to the end of the adapter 100 facing away from the plug 112. For example, it may be implemented as a mark that is adhered to the adapter 102.

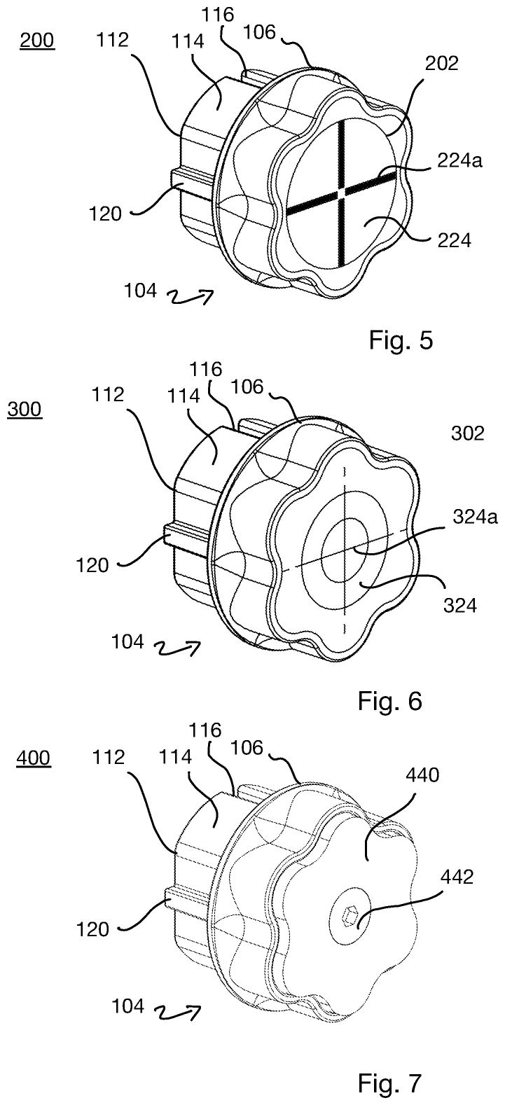

FIG. 5 shows a perspective view of an adapter 200, which represents a second embodiment. The adapter 200 differs from the adapter 100 of the first embodiment only by a measuring mark 202 with a different pattern 224. The latter has a crosshair 224a instead of four sectors in the second embodiment.

FIG. 6 shows a perspective view of an adapter 300 representing a third embodiment. The adapter 300 differs from the adapter 200 of the second embodiment only in having a measuring mark 302, which has a pattern 324 with modified crosshairs 324a.

FIG. 7 shows a perspective view of an adapter 400, which represents a fourth embodiment. In contrast to the previous embodiments, the adapter 400 has a mounting element in the form of an adapter plate 440 at its end facing away from the plug 112. The adapter plate 440 is attached to the adapter body 104, for example, by means of a screw connection 442. The adapter plate 440 serves to detachably attach the measuring mark to the adapter 400. For clarity, the measuring mark is omitted in FIG. 7.

In the embodiment shown in FIG. 7, for example, the measuring mark may be provided with a recess that is adapted in shape to the adapter plate 440. Thus, the recess and the adapter plate 440 adapted thereto each have the shape of a regular polygon with rounded corners. This makes it particularly easy for the user to insert the adapter plate 440 in the correct position in the recess of the measuring mark.

In the example shown, the adapter plate 440 is made of metal, e.g., a corrosion-resistant steel. Thus, the adapter plate 440 is suitable for interacting with a magnet to secure the measuring mark to the adapter 400. For this purpose, the measuring mark comprises, for example, a magnet arrangement attachable to the adapter plate 440. The magnet arrangement may be housed, for example, in a base of the measuring mark. This makes it possible to attach the measuring mark to the adapter 400 without additional fasteners.

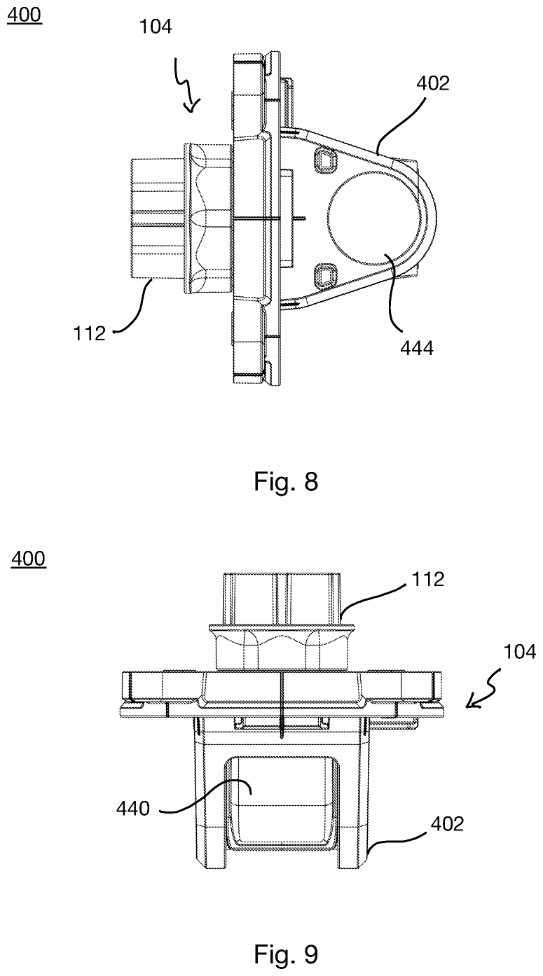

FIGS. 8 and 9 show two side views of the adapter 400 with a measuring mark 402 attached thereto. In this example, which is a fifth embodiment, the measuring mark 402 includes a prism 444 that can be tilted to align with the survey instrument. In the views shown in FIGS. 8 and 9, the adapter plate 440 via which the measuring mark 402 is attached to the adapter 400 is covered.

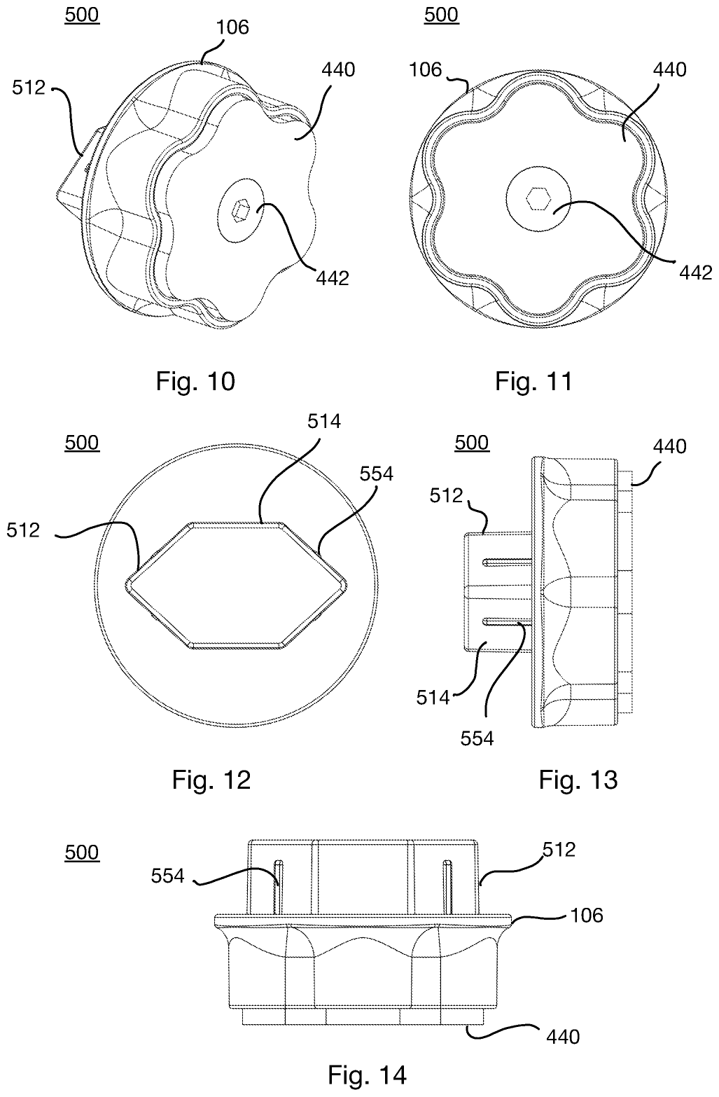

FIGS. 10 to 14 show an adapter 500, representing a sixth embodiment, in various views. Here, in FIG. 10 a perspective view, in FIG. 11 a front view, in FIG. 12 a rear view, in FIG. 13 a first side view and in FIG. 14 a different second side view of the adapter 500 is shown.

Like the adapter 400 shown in FIGS. 7 to 9, the adapter 500 includes the adapter plate 440 attached to the adapter body 104. The adapter 500 shown in FIGS. 10 to 14 differs from the preceding embodiments in that it is adapted to a different type of plug connection. In the present example, the adapter 500 has a plug 512 shaped according to a plug SN 441011/type 12. This type of plug represents a Swiss standard.

In accordance with this standard, the plug 512 forms an engagement portion that is hexagonal in plan view and is shaped to match a hexagonal socket portion of the matching socket. Elongated ribs 554 are formed on an outer circumferential surface 514 of the plug 512, which engage with correspondingly shaped grooves of the socket portion of the matching socket when the adapter 500 with its plug 412 is inserted into the socket.

Also in this embodiment, the plug 512 formed on the adapter 500 does not adopt the shape of the standardized plug type in all details. For example, in this example, the plug 512 does not have pin elements that would correspond to the contact pins that are present in the standardized plug type. Again, however, the shape of the plug 512 matches the shape of the standardized plug type, at least to the extent that the desired positive plug connection with the mating socket is achieved.

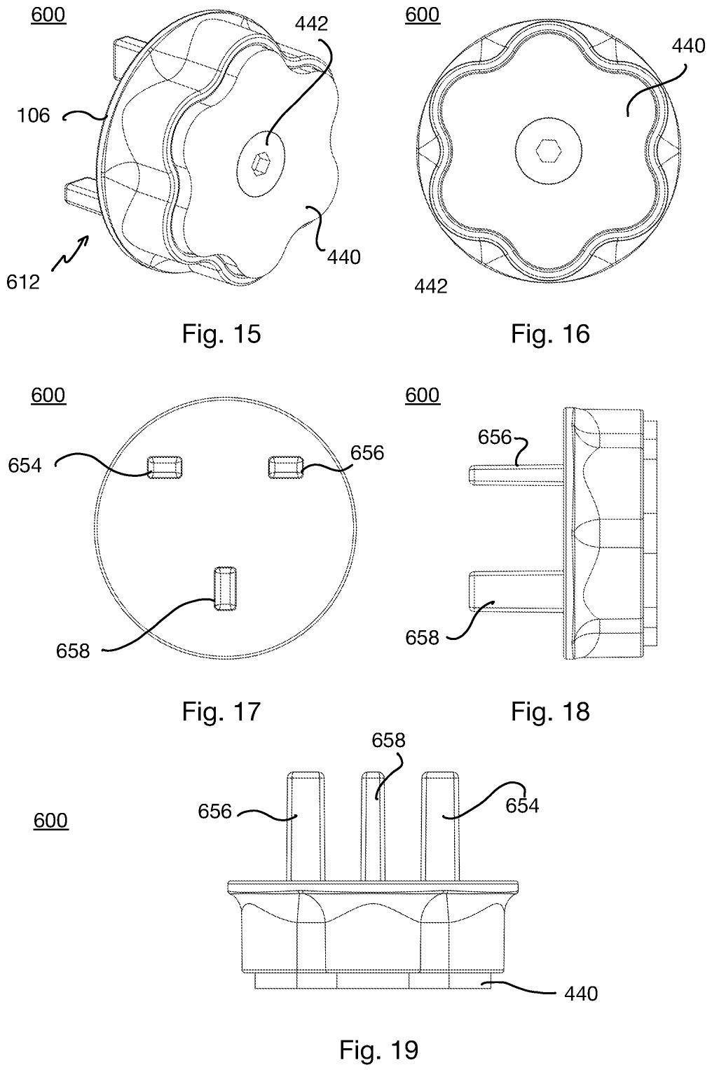

FIGS. 15 to 19 show an adapter 600, representing a seventh embodiment, in various views. Here, a perspective view is shown in FIG. 15, a front view is shown in FIG. 16, a rear view is shown in FIG. 17, a first side view is shown in FIG. 18, and a different second side view of the adapter 600 is shown in FIG. 19.

The adapter 600 differs from the adapter 500 of the sixth embodiment in that it is adapted to a different type of plug connection. For example, in this embodiment, the adapter 600 has a plug 612 shaped according to a type of plug commonly used in the United Kingdom (UK), which has three contact pins. Accordingly, the connector 612 of the adapter 600 also has three contact pins 654, 656, and 658. The two contact pins 654, 656 have the same dimensions. In contrast, the third contact pin 658 is wider.

When the adapter 600 with its plug 612 is inserted into the matching socket, the contact pins 654, 656, 658 engage with the associated contact openings of the socket. This establishes the positive connection with the socket. Since, in particular, the contact pins 654, 656, 658 are also made of an insulating material, it is ensured that the adapter 600 is electrically insulated from the socket.

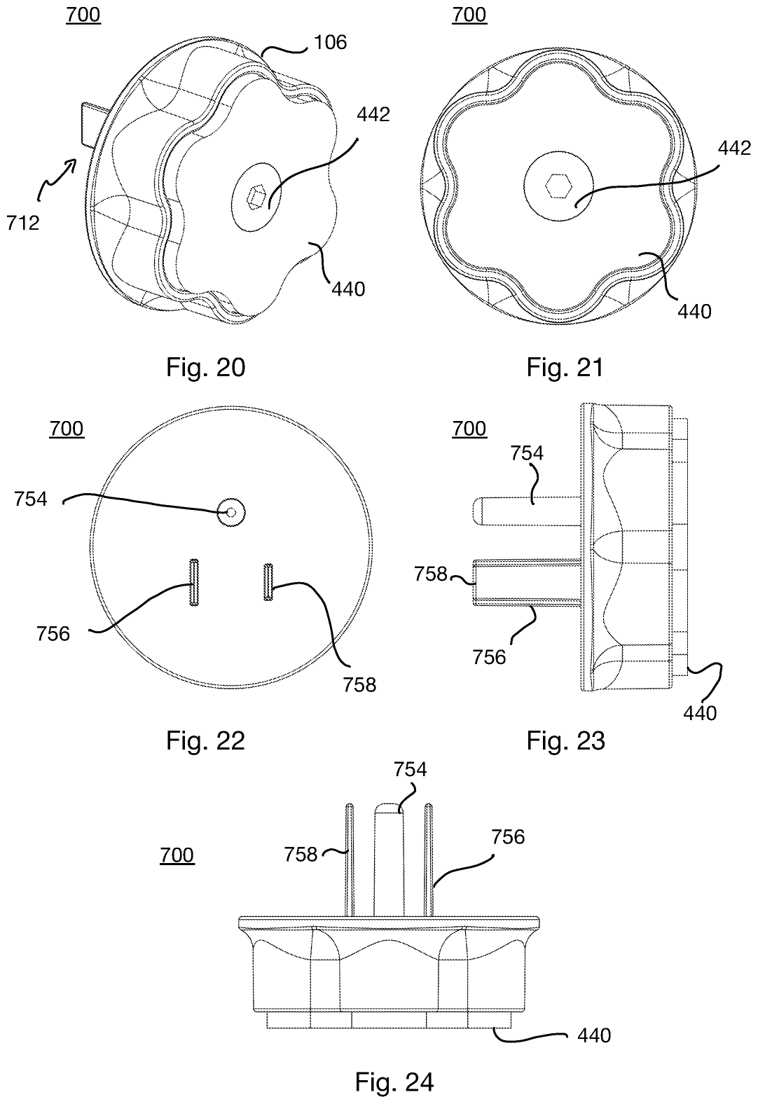

FIGS. 20 to 24 show an adapter 700, representing an eighth embodiment, in various views. Here, in FIG. 20 a perspective view, in FIG. 21 a front view, in FIG. 22 a rear view, in FIG. 23 a first side view and in FIG. 24 a different second side view of the adapter 600 is shown.

The adapter 700 differs from the adapters 500 and 600 of the preceding embodiments in that it is adapted to a different type of plug connection. For example, in this embodiment, the adapter 700 has a plug 712 that is shaped according to a plug type common to the other plug types in the United States. This type of plug also has three contact pins. Thus, the plug 712 of the adapter 700 also has three contact pins 754, 756, and 758. The two contact pins 756 and 758 have a flat shape and are of different widths. In contrast, the third contact pin 754 is round in cross-section.

When the adapter 700 with its plug 712 is inserted into the matching socket, the contact pins 754, 756, 758 engage with the associated contact openings of the socket. This establishes the positive connection with the socket. The contact pins 754, 756, 758 are also made of an insulating material.

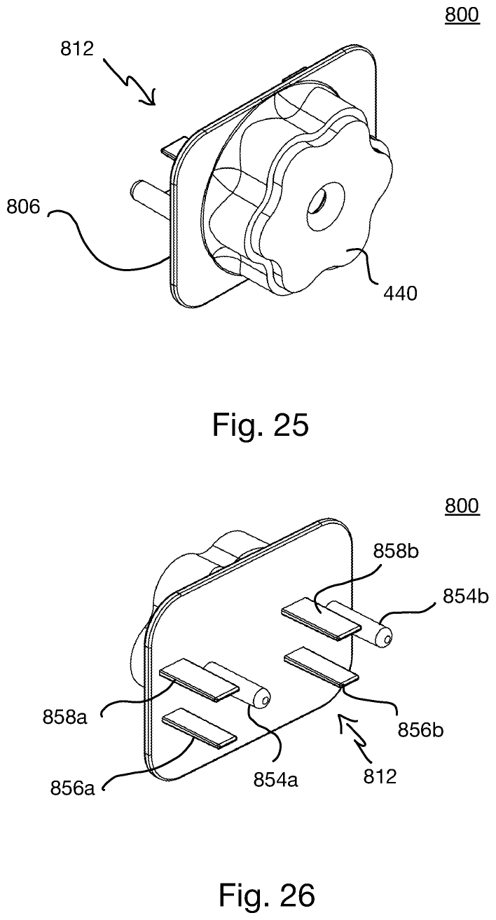

FIGS. 25 and 26 illustrate an adapter 800 as a ninth embodiment. FIG. 25 shows a front perspective view and FIG. 26 a rear perspective view of the adapter 800.

The 800 adapter is shaped according to another type of plug commonly used in the USA. This plug type has two groups of three contact pins each. Accordingly, a plug 812 of the adapter 800 also has two groups of three contact pins 854a, 856a, 858a and 854b, 856b, 858b, respectively. The contact pins 856a, 856b, 858a, 858b each have a flat design and are of different widths. The contact pins 854a, 854b are round in cross-section. The adapter 800 has a flange 806 that has a rounded rectangular shape, unlike the previous embodiments.

When the adapter 800 with its plug 812 is inserted into the matching socket, the contact pins 854a, 854b, 856a, 856b, 858a, 858b come into contact with the associated contact openings of the socket. This creates a positive connection with the socket. The contact pins 854a, 854b, 856a, 856b, 858a, 858b are made of an insulating material.

What is claimed is:

1. An adapter for mounting a measuring mark at a reference point, comprising:
an adapter body to which a measuring mark is fixedly attached or removably attachable, characterized in that at least a part of the adapter body is formed into a plug which is adapted to a socket serving as a reference point in such a way that it can be plugged into the socket to establish a positive plug connection and is electrically insulated from the socket in the plugged-in state.

2. The adapter according to claim 1, characterized in that the plug is shaped according to a network plug type usable for connection to a low-voltage network.

3. The adapter according to claim 1, characterized in that the adapter body has, at its end facing away from the plug, the measuring mark or a mounting element for detachably attaching the measuring mark.

4. The adapter according to claim 3, characterized in that the mounting element is an adapter plate to which the measuring mark can be detachably attached.

5. The adapter according to claim 4, characterized in that the adapter plate is made of metal.

6. The adapter according to claim 1, characterized in that the plug has at least one contact pin which can be inserted into an associated contact opening of the socket.

7. The adapter according to claim 1, characterized by at least one recess formed on an outer peripheral surface of the plug and adapted to a grounding lug of the socket and/or at least one protrusion formed on the outer peripheral surface of the plug and adapted to a recess of the socket.

8. The adapter according to claim 1, characterized in that the adapter as a whole is made of an electrically insulating material.

9. The adapter according to claim 1, characterized in that the adapter is made of an injection-molded part.

10. An arrangement comprising a socket and an adapter according to claim 1, wherein the plug of the adapter is insertable into the socket to establish a positive plug connection and is electrically insulated from the socket in the inserted state.

11. A method of surveying a reference point using an adapter according to claim 1, wherein the adapter is attached to a socket serving as a reference point by inserting the part of the adapter body shaped into the plug into the socket and thereby establishing a positive and electrically insulated connection with the socket.

12. A device for surveying a reference point, comprising an adapter according claim 1, and a measuring mark removably attached to the adapter body.

13. The device according to claim 12, characterized in that the measuring mark comprises a recess adapted in shape to the adapter plate.

14. The device of claim 13, characterized in that the measuring mark comprises a magnet arrangement attachable to the adapter plate made of metal.

15. The device of claim 12, characterized in that the measuring mark comprises one of a reflective target mark, an adhesive mark, a survey badge, a prism, a laser scanner mark, or a laser scanner sphere.
